(19) United States
(12) Patent Application Publication
(10) Pub. No.: US 2010/0104897 A1
(43) Pub. Date: Apr. 29, 2010

(54) FUEL PROCESSING METHOD FOR SOLID OXIDE FUEL CELL SYSTEM

(75) Inventors: Joongmyeon BAE, Daejeon (KR); Sangho YOON, Daejeon (KR); Sunyoung KIM, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: KOREA ADVANCED INSTITUTE OF SCIENCE AND TECHNOLOGY, Daejeon (KR)

(21) Appl. No.: 12/429,549

(22) Filed: Apr. 24, 2009

(30) Foreign Application Priority Data
Oct. 27, 2008 (KR) 10-2008-0105294

(51) Int. Cl. H01M 8/04

(52) U.S. Cl. 429/17

(57) ABSTRACT

A fuel processing method performed in a solid oxide fuel cell system can completely remove a hydrocarbon remaining in a reformed gas, thereby preventing deteriorated fuel cell performance. The method comprises (a) removing sulfur from a hydrocarbon-based fuel and obtaining hydrogen-rich reformed gas using a desulfurizer that removes the sulfur and a primary-reformer that reforms the hydrocarbon-based fuel to generate the hydrogen-rich reformed gas; and (b) selectively decomposing a low carbon hydrocarbon of C₂˜C₅ contained in desulfurized reformed gas and converting it into hydrogen and methane using a post-reformer.

### TECHNICAL FIELD

The present invention relates to a fuel processing method for a solid oxide fuel cell system, and particularly, to a fuel processing method for a solid oxide fuel cell system, which can completely remove a hydrocarbon compound remained in a reformed gas, thereby preventing deterioration in performance of a fuel cell.

### BACKGROUND ART

According to industrial development and population growth, the demand for energy has been rapidly increased around the world. However, it has been estimated that production of oil and natural gas as main energy sources will be gradually reduced starting the year 2020. Therefore, just in case of the drain on fossil fuel resources, research and development on alternative clean energy sources is required.

As the Kyoto protocol aiming for limiting greenhouse gas emissions had been adopted in the year 1997 and ratified in 119 countries including Korea, the countries have agreed to control and/or reduce emission in the atmosphere of greenhouse gases.

Various technologies using clean natural resources such as solar energy, wind force and hydrogen energy has been studied and developed. Recently, SOFC (Solid Oxide Fuel Cell) technology comes into the spotlight as a clean energy because of reasons as follows:

1) Since it uses a method of direct generation of electric power which is not necessary for combustion processes and mechanical actions unlike in existing thermal power generation, it is not limited thermodynamically (Carnot efficiency), it has a high electric power generation efficiency of 40˜60% and also it has a substantially constant efficiency over a wide load range, e.g., 25˜100% of rated power. 2) It does not exhaust NOx, SOx and the like and can reduce CO₂ emissions of 30% or more, and it is an eco-friendly technology that its operation noise/vibration is very immaterial. 3) It can use a method of distributed generation of electric power and thus it can directly generate and supply the electric power at home and in an industrial site. Therefore, a power transmission/distribution system is not needed. 4) Since its power generation capacity can be facilely adjusted, it can be used as a middle/large-scaled power generation system of 100 kW˜a few tens MW class, a small-scaled home power generation system of 1 kW˜10 kW class and a mobile power generation system of a few W˜a few kW class.

The SOFC is an energy conversion device in which chemical energy of fuel gas is directly converted into electric energy by an electrochemical reaction. According to the electrochemical reaction of the SOFC, in a fuel electrode, hydrogen releases electrons and reacts with oxygen ions moved through an electrolyte to generate water and heat. The electrons generated in the fuel electrode move to an air electrode while generating direct current, and combines with oxygen in the air electrode to generate oxygen ions. The generated oxygen ions move through the electrolyte to the fuel electrode.

A potential difference obtained from one basic unit cell comprised of the fuel electrode, the electrolyte and the air electrode is about 1V. Accordingly, in order to use the fuel cell as a power source, it is necessary to construct a fuel cell system having a fuel cell stack in which a plurality of unit cells are connected in series or parallel with each other.

A typical fuel cell system includes a SOFC stack for generating electric power, a fuel processing device for supplying hydrogen/hydrocarbon and oxygen to the stack, a power conversion system for converting DC power generated from the SOFC stack into AC power, and a heat recovery device for recovering heat generated from the SOFC.

According to a used electrolyte material, the fuel cell can be classified into an alkaline fuel cells (AFC), a phosphoric acid fuel cell (PAFC), a polymer electrolyte membrane cells (PEMFC), a molten carbonate fuel cell (MCFC), and a solid oxide fuel cell (SOFC). In case of the PEMFC, the most particular fuel processing method is required. And in case of SOFC, fuel can be sufficiently processed by internal reforming in a stack.

The fuel reforming in the fuel cell is to converting fuel provided as a raw material into fuel required for the stack.

In the PEMFC, after performing a desulfurization process which removes a sulfur component from natural gas, a reforming process which generates hydrogen is performed. Then, a water shift reaction for removing CO generated in the reforming process and a selective oxidation reaction are additionally performed, and a CO concentration should be controlled to be not more than 100 ppm by the water shift reaction. However, in the SOFC, since CO itself can be used as a fuel, the fuel can be sufficiently processed only by the internal reforming using catalytic materials provided in the fuel cell stack. Further, since the SOFC is operated at a high temperature, it can use CH4 as well as CO as the fuel.

The table 1 described below shows available fuels, conductive ion materials, fuel reforming methods and technical problems according to the kinds of fuel cells.

TABLE 1

| Fuel cell | MCFC | SOFC | PAFC | PEMFC | DMFC |
|---|---|---|---|---|---|
| Operation | 550~700 | 600~1000 | 150~250 | 50~100 | 50~100 |
| temperature | | | | | |
| (° C.) | | | | | |
| Ion | CO₃²⁻ | O²⁻ | H⁺ | H⁺ | H⁺ |
| Available | H₂, CO | H₂, CO, | H₂, | H₂ | methanol |
| fuel | | methane | methanol | | |
| External | unnecessary | unnecessary | necessary | necessary | necessary |
| reformer | | | | | |
| problem | Corrosion, | High | Corrosion, | High | High |
| | volatilization | temperature | Leak of | expense, | expense, |
| | | deterioration, | phosphoric | low | methanol |
| | | stability | acid | efficiency | crossover |

As shown in Table 1, in case of the PAFC, the PEMFC and the DMFC which are low temperature fuel cells using a platinum-based catalyst, it is necessary to reduce and limit the CO concentration contained in a reformed gas using an external reformer so as to prevent deterioration of the catalyst. However, in case of the MCFC and the SOFC which uses a nickel-based catalyst, since it is possible to use the CO as fuel, it is not necessary to remove the CO, and also since a reforming reaction can occur in a fuel electrode containing nickel (internal reforming), the external reformer is not needed.

Generally, a water vapor reforming using the nickel catalyst is used to reform hydrocarbon-based fuel. In other words, the reforming reaction is to react the hydrocarbon-based gas with the water vapor under the nickel catalyst and thus to generate CO and H₂. Since the reforming reaction is an endothermic reaction, it is necessary to supply heat from an outside.

A partial oxidation reforming which reacts the hydrocarbon-based gas with oxygen so as to generate CO and H₂, and an autothermal reforming which combines the water vapor reforming and the partial oxidation reforming can be used besides the partial oxidation reforming.

Then, in the low temperature fuel cell which uses the platinum-based catalyst as an electrode catalyst, a shift reaction in which the water vapor is reacted again with CO so as to oxidize CO into CO₂ is performed.

Then, if necessary, in order to reduce the CO concentration to 10 ppm or less, the selective oxidation reaction in which CO is selectively oxidized under an atmosphere having a high hydrogen concentration is performed.

As described above, since the SOFC and the MCFC use a nickel-based fuel electrode and operated at a high temperature, CO can be used as the fuel, and since hydrocarbon can be also used by the internal reforming in the fuel electrode, a fuel reformer for the SOFC can be comprised of only a desulfurizer for removing sulfur in the fuel or the desulfurizer and a pre-reformer.

At this time, in case that liquid hydrocarbon is used as the fuel, it is not possible to obtain a sufficient reforming efficiency by only the pre-reformer and the internal reforming in the stack, and thus the fuel reformer for the SOFC is typically comprised of the desulfurizer and the reformer. However, due to the property of the SOFC which is operated at a high temperature, CO and methane contained in hydrogen can be used as fuels, and thus reforming conditions are not strict in general.

As a conventional SOFC system with an external reformer, there has been proposed Japanese Patent Publication No. 2006-351293 which includes a desulfurizer for removing sulfur contained in liquid fuel, an evaporator for forming reforming fuel from the liquid fuel and water, a reformer for generating hydrogen-rich gas from the reforming fuel, and a solid electrolyte SOFC cell.

In Japanese Patent Publication No. 2006-351293, the SOFC system includes a desulfurizing device for removing sulfur contained in hydrocarbon fuel, the reformer for generating the hydrogen-rich gas from the desulfurized hydrocarbon fuel, and the solid electrolyte SOFC cell. Particularly, the desulfurizing device includes a desulfurizer for removing a sulfur compound, a desulfurized fuel tank for storing the desulfurized hydrocarbon fuel and a return passage communicated from the desulfurized fuel tank to the desulfurizer.

There has been also proposed a fuel processing apparatus in U.S. Patent Publication No. 2007-0092766, which includes a liquid phase desulfurizer for partially removing sulfur from liquid phase fuel, a fuel conveying device for vaporizing and conveying the partially desulfurized liquid phase fuel, a gas phase desulfurizer for desulfurizing the vaporized fuel, and a reformer for generating hydrogen-rich gas.

Even in the SOFC system using the liquid fuel, as described above, the main consideration is to efficiently remove the sulfur component. The fuel reforming is just to generate the hydrogen-rich gas using the single reformer. In this case, non-converted low carbon (C₂˜C₅) hydrocarbon, which is not yet converted, is continuously supplied as the fuel to the SOFC and thus carbon deposition occurs in the fuel cell, thereby deteriorating the performance of the system.

The present invention provides a method of preventing the high temperature deterioration which is the biggest obstacle to industrialize and commercialize the SOFC and also improving the stability of performance. In other words, since the low carbon (C₂˜C₅) hydrocarbon material, which is not converted in the reformer and is contained in fuel injected into a SOFC cell (stack), exerts a bed effect on the high temperature deterioration and the stability of performance, a post-reformer for selectively removing the low carbon hydrocarbon is provided to thereby prevent the deterioration of performance of the fuel cell system and maintain the reliability and stability for a long time period.

### DISCLOSURE OF THE INVENTION

It is an object of the present invention to provide a method of reforming hydrocarbon-based fuel supplied to a SOFC cell or a SOFC stack, which can prevent the deterioration of performance of the SOFC cell and maintain the stability for a long time period, and particularly, to provide a fuel processing method which can selectively remove the low carbon hydrocarbon having a carbon number of C₂˜C₅.

To achieve the above object, the present invention provides A fuel processing method for a solid oxide fuel cell system, comprising removing sulfur from a hydrocarbon-based fuel and obtaining hydrogen-rich reformed gas using a desulfurizer for removing the sulfur and a primary-reformer for reforming the hydrocarbon-based fuel to generate the hydrogen-rich reformed gas; and selectively decomposing a low carbon hydrocarbon compound of C₂˜C₅ contained in desulfurized reformed gas and converting it into hydrogen and methane using a post-reformer.

Preferably, The fuel processing method, wherein the removing of sulfur from a hydrocarbon-based fuel and the obtaining of hydrogen-rich reformed gas using the desulfurizer for removing the sulfur and the primary-reformer for reforming the hydrocarbon-based fuel to generate the hydrogen-rich reformed gas comprises obtaining the hydrogen-rich reformed gas from the hydrocarbon-based fuel using the primary-reformer; and removing sulfur from the reformed gas using the desulfurizer.

Preferably, The fuel processing method, wherein selectively decomposing a low carbon hydrocarbon compound of C₂˜C₅ is to selectively convert non-converted hydrocarbon-based fuel, i.e., the low carbon hydrocarbon compound of C₂˜C₅ contained the desulfurized reformed gas into hydrogen, carbon monoxide and methane, and the post-reformer is provided with a catalyst formed of a transition metal, a noble metal or a mixture thereof, and the low carbon hydrocarbon compound of C₂˜C₅ is converted into hydrogen and methane by the catalyst.

Preferably, the transition metal includes Ni, Mg and a mixture thereof, and the noble metal includes Pt, Rh, Pd, Ru and a mixture thereof.

Preferably, The fuel processing method, wherein the selectively decomposing of the low carbon hydrocarbon compound of C₂˜C₅ contained in desulfurized reformed gas and the converting of it into hydrogen and methane using the post-reformer is performed at 400˜600 in order to efficiently convert the low carbon hydrocarbon compound (C₂˜C₅) and obtain a high reforming efficiency.

In the step of selectively decomposing of the low carbon hydrocarbon compound of C₂˜C₅, the desulfurized reformed gas is supplied to the post-reformer and then selectively reacted with other hydrogen and vapor contained in the low carbon hydrocarbon compound of C₂˜C₅ by the post-reforming catalyst to be converted into hydrogen and methane, and the reformed gas that is discharged from the post-reformer through the primary-reformer and the desulfurizer is supplied to the SOFC cell or the SOFC stack.

Preferably, The fuel processing method, wherein an autothermal reforming reaction among fuel, air and water is performed in the primary-reformer of the obtaining of the hydrogen-rich reformed gas from the hydrocarbon-based fuel using the primary-reformer, and an adsorption reaction of a sulfur compound with respect to the catalyst is performed in the desulfurizer of the removing of sulfur from the reformed gas using the desulfurizer, and heat generated from the adsorption reaction and the autothermal reaction is used as a heat source for the selectively decomposing of the low carbon hydrocarbon compound of C₂˜C₅ contained in desulfurized reformed gas and the converting of it into hydrogen and methane using the post-reformer.

The fuel processing method of the present invention can efficiently remove the non-converted hydrocarbon compounds, i.e., low carbon hydrocarbon compounds having a carbon number of C₂˜C₅, and thus it is possible to prevent the deterioration of performance of the SOFC and to increase the stability of the SOFC and the fuel cell system for a long time period, and also it can be thermally independent without the external heat.

### BRIEF DESCRIPTION OF THE DRAWINGS

FIG. 1 is a flow chart showing a fuel processing method for a SOFC system according to an embodiment of the present invention.

FIG. 2 is a flow chart showing a fuel processing method for a SOFC system according to another embodiment of the present invention.

FIG. 3 is a schematic block diagram of an apparatus for performing the fuel processing method for a SOFC system according to an embodiment of the present invention.

FIG. 4 is a graph showing results of analyzing reformed gas of a model diesel synthetic fuel through a reformer and reformed gas of a model diesel synthetic fuel through a reformer and a post-reformer.

FIG. 5 is a graph showing the more detailed results of FIG. 4.

FIG. 6 is a schematic view of an apparatus for performing the fuel processing method for a SOFC system according to another embodiment of the present invention.

### BEST MODE FOR CARRYING OUT THE INVENTION

Hereinafter, the embodiments of the present invention will be described in detail with reference to accompanying drawings. The drawings are just examples for explaining ideas in the present invention, and thus the present invention are not limited to the drawings but can be realized in the form of other type. The same reference numerals are used for the same or similar parts the drawings.

Unless defined otherwise, all technical terms and scientific terms used herein the same means as commonly understood by one of ordinary sill in the art to which this invention belongs, and well-known functions and constructions in the drawings and the description, which may undesirably becloud the subject matters of the present invention, will be omitted.

A fuel processing method of the present invention is to supply fuel in a SOFC cell or stack, and the fuel to be processed is gas phase or liquid phase hydrocarbon-based fuel. Preferably, the fuel is the liquid phase hydrocarbon-based fuel. At this time, the liquid phase hydrocarbon-based fuel includes kerosene, light oil, naphtha, gasoline and liquefied petroleum gas (LPG).

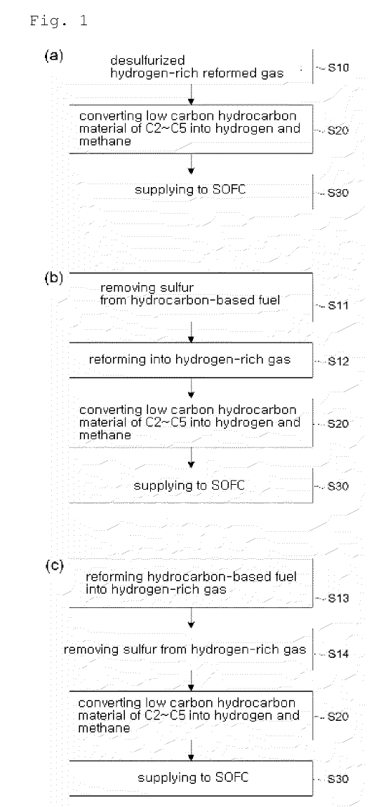

FIG. 1 is a flow chart showing a fuel processing method for a SOFC system according to an embodiment of the present invention. In the fuel processing method, instead of a process that reformed gas in which sulfur is removed by a desulfurizing process and a reforming process (S10) like in a conventional method is supplied to the SOFC cell, a decomposition reaction (S20) in which non-reacted hydrocarbon-based fuel contained in the reformed gas, particularly, a low carbon hydrocarbon compound of C₂˜C₅ is selectively converted into hydrogen and methane is performed, and thus gas containing the lower carbon hydrocarbon of 10 ppm or less is supplied to the SOFC cell or the SOFC stack (S30), as shown in FIG. 1a.

Alternatively, as shown in FIG. 1b, after a desulfurizing process (S11) for removing a sulfur component from the hydrocarbon-based fuel using a desulfurizer is performed, a reforming process (S12) for converting the desulfurized hydrocarbon-based fuel into hydrogen-rich reformed gas is performed in a reformer and then a decomposition reaction (S20) in which non-reacted hydrocarbon-based fuel contained in the desulfurized reformed gas, particularly, the low carbon hydrocarbon compound of C₂˜C₅ is selectively converted into hydrogen and methane is performed. Otherwise, as shown in FIG. 1c, after a reforming process (S13) for converting the hydrocarbon-based fuel into the hydrogen-rich reformed gas is performed in a reformer, a desulfurizing process (S14) for removing the sulfur component from the reformed gas, and then a decomposition reaction (S20) in which non-reacted hydrocarbon-based fuel contained in the desulfurized reformed gas, particularly, the low carbon hydrocarbon compound of C₂˜C₅ is selectively converted into hydrogen and methane is performed.

In the fuel processing method, the low carbon hydrocarbon material having a carbon number of C₂˜C₅ which is converted into hydrogen and methane includes ethylene, acetylene, ethane, propylene, propane and butane.

In case that the hydrogen-rich reformed gas containing the low carbon hydrocarbon material of C₂˜C₅ is supplied to the SOFC cell, carbon deposition occurs in the SOFC cell, thereby reducing an operational efficiency of the SOFC system when it is used for a long time period and also deteriorating the performance and stability of the SOFC system.

The deterioration of performance due to the low carbon hydrocarbon material of C₂˜C₅ raises a further serious problem in the SOFC in which the hydrocarbon-based liquid fuel is reformed. In case of the liquid fuel that a fuel converting (reforming) operation is complicated and difficult, it is very difficult to convert the fuel using only a pre-reformer like in the gas fuel, and also although a reformer as an external reformer is provided, a large amount of non-converted hydrocarbon, i.e., the low carbon hydrocarbon material of C₂˜C₅ is contained in the reformed gas when reforming the liquid fuel, thereby reducing the stability of the fuel cell.

The fuel processing method of the present invention further includes a post-reforming process for removing the non-converted hydrocarbon, i.e., the low carbon hydrocarbon material of C₂˜C₅ after hydrogen-rich reformed gas is generated by the reformer but before the reformed gas is supplied to the SOFC cell. Preferably, the post-reforming process is performed through the post-reformer.

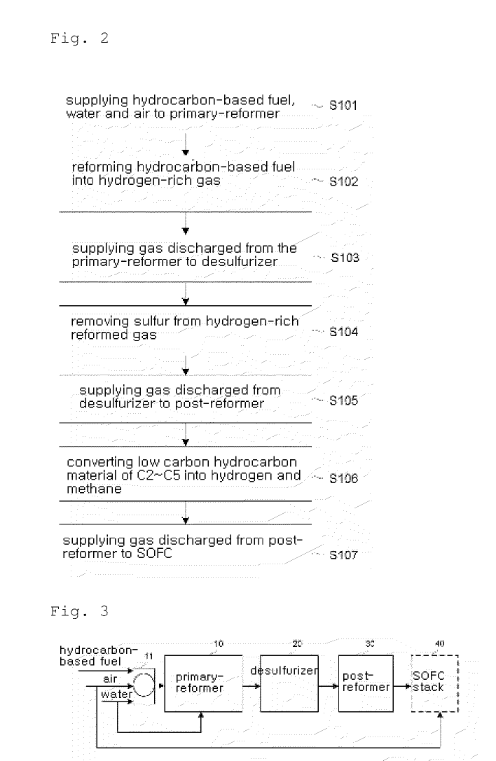

FIG. 2 is a flow chart showing a preferable fuel processing method according to the present invention, and FIG. 3 is a schematic block diagram of an apparatus for performing the fuel processing method according to the present invention. As shown in FIGS. 2 and 3, the fuel processing method of the present invention preferably includes supplying water, hydrocarbon-based fuel and air to a reformer 10 which reforms the hydrocarbon-based fuel to generate hydrogen-rich reformed gas (S101), reforming the hydrocarbon-based fuel using the reformer 10 (S102), supplying the reformed gas discharged from the reformer 10 to a desulfurizer 20 which removes a sulfur component (S103), desulfurizing the reformed gas in the desulfurizer 10 (S104), supplying gas discharged from the desulfurizer 20 to a post-reformer 30 (S105), and selectively decomposing non-converted (non-reformed) hydrocarbon-based fuel (low carbon hydrocarbon material of C₂˜C₅) into hydrogen and methane in the post-reformer 30 (S106). The gas discharged from the post-reformer 30 is supplied to the SOFC cell (stack) 40 (S107).

Preferably, in the process of S101, the water, the hydrocarbon-based fuel and the air are supplied through an injection nozzle 11 to the reformer, and the reformer may be further provided with a separate water supplying line except the injection nozzle.

The post-reformer 30 in which the non-converted hydrocarbon-based fuel (low carbon hydrocarbon material of C₂˜C₅) is converted into hydrogen and methane (a post-reforming process) so as to supply hydrogen, carbon monoxide and methane to the SOFC is provided with a post-reforming catalyst formed of a transition metal, a noble metal or a mixture thereof, and thus the low carbon hydrocarbon material of C₂˜C₅ is composed into hydrogen and methane by the catalyst.

The transition metal of the post-reforming catalyst includes Ni, Mg and a mixture thereof, and the noble metal includes Pt, Rh, Pd, Ru and a mixture thereof.

In order to efficiently convert the low carbon hydrocarbon material (C₂˜C₅) and obtain a high reforming efficiency, it is preferable that the process of selectively decomposing non-converted hydrocarbon-based fuel into hydrogen and methane is performed at a temperature of 400˜600° C.

The reformer and desulfurizer are typically operated according to operational conditions of the SOFC system. At this time, a temperature of the reforming process (S102) can be controlled by an inflow of the hydrocarbon-based fuel, the water and the air, and a mixed ratio of hydrocarbon-based fuel, the water and the air, and a temperature of the desulfurizing process (S104) can be controlled by a cooled status of a passage for supplying fluid from the reformer and the desulfurizer, a length of the passage and the like. A temperature of the post-reforming process (S106) can be controlled by a volume of the reformer, a volume of the post-reformer, a volume of the desulfurizer, a contacted surface area between the reformer and the post-reformer, a contacted surface area between the desulfurizer and the post-reformer, a first fluid conveying distance that the gas discharged from the desulfurizer is conveyed to the post-reformer, a second fluid conveying distance that the gas discharged from the reformer is conveyed to the desulfurizer, an inflow of the hydrocarbon-based fuel, the water and the air introduced into the reformer, a mixed ratio of the hydrocarbon-based fuel, the water and the air introduced into the reformer, and a combination thereof.

In order to select a preferable temperature for the post-reforming process (S106), components of the gas reformed by only the reformer were analyzed and then the gas reformed by the same reformer was reformed again by the post-reformer which was maintained at various temperatures so as to estimate a post-reformer effect. According to the results, the low carbon hydrocarbon material was remained in the gas discharged from the reformer, and also the low carbon hydrocarbon material could be completely removed by the post-reformer maintained at a temperature of 300˜600° C.

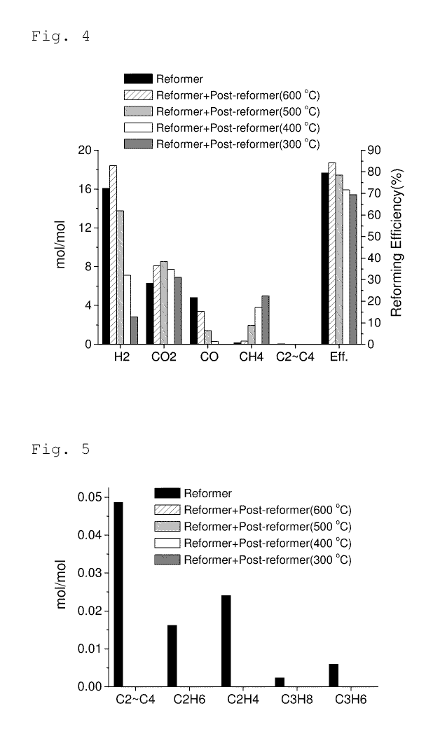

Speaking more detailedly, a model diesel synthetic fuel was introduced into the reformer which has a ceria-based support impregnating Pt of 0.5 weight % and was maintained at 800° C., and then the reformed gas and discharged gas from the reformer were introduced into the post-reformer which was provided with alumina (13.5 weight %), silica (18.2 weight %), Ni (55.3 weight %) and Mg (13 weight %) and was maintained at 300˜600° C., and then the discharged gas from the post-reformer was analyzed. The results are shown in FIGS. 4 and 5, wherein ‘reformer+post-reformer’ shows the results of analyzing the reformed gas using the reformer and the post-reformer in various temperature ranges.

FIGS. 4 and 5 show concentrations of the gases obtained by reforming the model diesel synthetic fuel. As shown in FIGS. 4 and 5 comparing the generated gas using only the reformer and the generated gas using the reformer and the post-reformer, hydrogen-rich gas can be obtained from the generated gas obtained by using the reformer but the generated gas contains the non-converted low carbon hydrocarbon material (C₂˜C₄) which exerts a bad effect on the performance of the SOFC. However, in case of operating the reformer together with the post-reformer, as shown in FIG. 5, the non-converted low carbon hydrocarbon material can be completely removed in the entire operational temperature range of the post-reformer. Therefore, it can be confirmed that the non-converted low carbon hydrocarbon material generated from the reformer can be completely and effectively removed by using the post-reformer.

Meanwhile, it can be also confirmed that, as the operational temperature of the post-reformer is lowered, a concentration of hydrogen in the generated gas is reduced and thus the performance of the reformer is deteriorated. This is quantitatively shown by the reforming efficiency of FIG. 4. Therefore, in order to remove the non-converted hydrocarbon material by using the post-reformer and also improving the reforming efficiency, it is preferable that the operational temperature of the post-reformer is 400˜600° C., more preferably, 500˜600° C. In case that the operational temperature of the post-reformer is 500˜600° C., it can be possible to completely remove the low carbon hydrocarbon material discharged from the reformer and also to obtain the reforming efficiency which is similar to or slightly larger than the efficiency when using only the reformer.

According to the fuel processing method of the present invention, the post-reforming process (S106) can be thermally independent without heat separately supplied from an outside.

In other words, the decomposition reaction of the post-reformer (S106) can be performed using the heat generated from the reforming process (S102) using the reformer and the desulfurizing process (S104) using the desulfurizer.

In the reforming process (S102), the reformer uses a noble metal as a catalyst and receives the hydrocarbon-based fuel, the air and the water, and an autothermal reforming reaction among the hydrocarbon-based fuel, the air and the water is performed. At this time, the noble metallic catalyst provided in the reformer includes Pt, Rh, Ru, Au, Pd and a mixture thereof, and by using the heat of reaction generated in the reforming reaction, the reforming reaction is continuously performed without the external heat.

The desulfurizer in the desulfurizing process (S104) is provided with a desulfurizing catalyst in which an adsorption reaction of a sulfur compound with respect to the catalyst is performed. Preferably, the desulfurizing catalyst provided in the desulfurizer is ZnO. Also, due to the heat of reaction generated in the desulfurizing process (S104), the desulfurizing process (S104) can be continuously performed without the external heat.

Therefore, the heat generated in the autothermal reforming reaction of the reforming process (S102) and also in the adsorption reaction of the desulfurizing process (S104) is used as a heat source for the post-reforming process (S106) which is an endothermic reaction. Thus, in the fuel processing method of the present invention, the processes (S102, S104 and S106) can be thermally independent without the external heat.

In the reforming process (S102), it is preferable that the noble metallic catalyst is impregnated in a porous support (including a support having through-pores along a fluid conveying direction) through which the fluid can be passed and the hydrocarbon-based fuel, the air and the water are supplied, and the autothermal reforming reaction among the hydrocarbon-based fuel, the air and the water is performed. And also it is preferable that an amount of the noble metallic catalyst impregnated in the support is properly controlled according to a kind of hydrocarbon-based fuel to be reformed, an amount of the fuel and the like.

In the desulfurizing process (S104), it is preferable that the desulfurizing catalyst is impregnated in a porous support (including a support having through-pores along a fluid conveying direction) through which the fluid can be passed, and the adsorption reaction of a sulfur compound with respect to the catalyst is performed. And it is preferable that an amount of the desulfurizing catalyst impregnated in the support is properly controlled according to a kind of reformed hydrocarbon-based fuel, an amount of the reformed gas and the like.

In the post-reforming process (S106), it is preferable that the post-reforming catalyst is impregnated in a porous support (including a support having through-pores along a fluid conveying direction) through which the fluid can be passed, or a mixture of the post-reforming catalyst and an alumina-based, silica-based and ceria-based material which can be used as a support is contacted with the desulfurized gas so that the low carbon hydrocarbon material of C₂˜C₅ is selectively decomposed into hydrogen and methane. And it is preferable that an amount of the post-reforming catalyst impregnated or mixed in the support is properly controlled according to a kind of desulfurized reformed gas that is introduced into the post-reformer, an amount of the introduced gas and the like.

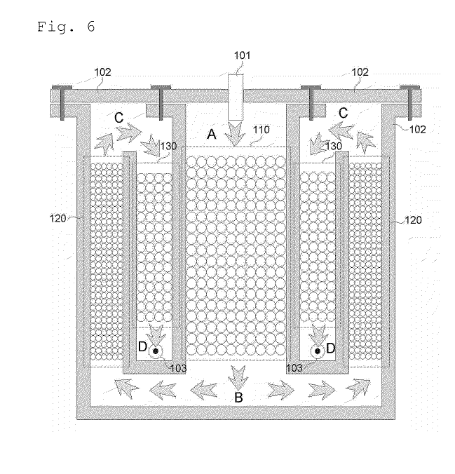

FIG. 6 shows an apparatus for performing the fuel processing method of the present invention, which can be thermally independent and also have a small size. As shown in FIG. 6, for the efficient thermal independence of the apparatus for performing the fuel processing method of the present invention, the reformer as an exothermic element and the post-reformer as an endothermic element are disposed to be adjacent to each other, and the desulfurizer as an exothermic element and the post-reformer as an endothermic element are also disposed to be adjacent to each other. At this time, the heat generated from the reformer and the desulfurizer may be supplied to the post-reformer by using a heat exchanger and the like.

As shown in FIG. 6 it is preferable that the fuel processing method according to the present invention is performed in a single reactor. An injection device 101 for injecting the hydrocarbon-based fuel, the water and the air into a reactor air-tightly closed by a single external wall 102, preferably, an injection nozzle 101 is provided at an upper portion of the reformer. Mixed reactants (A: a mixture of the hydrocarbon-based fuel, the water and the air) introduced through injection nozzle 101 is reformed into the hydrogen-rich reformed gas by the reformer 110 having the noble metallic catalyst, and the reformed gas (B) is introduced into the desulfurizer 120 having an ZnO catalyst for adsorbing the sulfur compound and then desulfurized, and the desulfurized reformed gas (C) is introduced into the post-reformer 130 having the post-reforming catalyst and the non-converted hydrocarbon-based fuel, i.e., the low carbon hydrocarbon material of C₂˜C₅ contained in the desulfurized reformed gas (C) is converted into hydrogen and methane, and then the reformed gas (D) according to the present invention is discharged to an outside of the reactor through a gas outlet port 103 and then supplied to the SOFC cell/stack.

In other words, as shown in FIG. 6, the reformer 110 is provided at a center portion of the single reactor is covered with an internal wall except both sides thereof through which the fluid is flowed, and the reformed gas (B) discharged through the reformer 110 is introduced into the desulfurizer 120 provided at the outermost of the reactor, and the desulfurizer 120 is converted by internal and external walls except both sides thereof through which the fluid is flowed. The desulfurized reformed gas (C) discharged from the desulfurizer 120 is introduced into the post-reformer 130 provided between the reformer 110 and the desulfurizer 120. The post-reformer 130 is covered with an internal wall except one side through which the fluid is introduced. The reformed gas (D) discharged from the post-reformer 130 is discharged to an outside of the reactor through the gas outlet port 103 provided at the other side of the post-reformer opposed to the fluid inlet side.

The heat necessary for the reaction in the post-reformer 130 uses the reaction heat generated in the reformer 110 and the desulfurizer 120, and thus the reaction in the post-reformer 130 can be performed without the external heat.

In order for the post-reformer 130 to efficiently use the heat generated in the reactor, it is preferable that the post-reformer 130 is disposed between the reformer 110 and the desulfurizer 120. Also, it is preferable that the post-reformer 130 and the desulfurizer 120 are concentrically disposed around the reformer 110.

In order to improve a processing efficiency in the same volume of the reactor, it is preferable that a cross-section of the reformer 110, the post-reformer 130 and the desulfurizer 120 which are separated by partition walls except the fluid passage has a concentric circular structure.

### INDUSTRIAL APPLICABILITY

The fuel processing method of the present invention can efficiently remove the non-converted hydrocarbon compounds, i.e., low carbon hydrocarbon compounds having a carbon number of C₂˜C₅, and thus it is possible to prevent the deterioration of performance of the SOFC and to increase the stability of the SOFC and the fuel cell system for a long time period, and also it can be thermally independent without the external heat.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A fuel processing method performed in a solid oxide fuel cell system, comprising
removing sulfur from a hydrocarbon-based fuel and obtaining hydrogen-rich reformed gas using a desulfurizer that removes the sulfur and a primary-reformer that reforms the hydrocarbon-based fuel to generate the hydrogen-rich reformed gas; and
selectively decomposing a low carbon hydrocarbon compound of C₂˜C₅ contained in desulfurized reformed gas and converting it into hydrogen and methane by using a post-reformer.

2. The fuel processing method as set forth in claim 1, wherein the removing of sulfur from a hydrocarbon-based fuel and the obtaining of hydrogen-rich reformed gas using the desulfurizer that removes the sulfur and the primary-reformer that reforms the hydrocarbon-based fuel to generate the hydrogen-rich reformed gas comprises
obtaining the hydrogen-rich reformed gas from the hydrocarbon-based fuel by using the primary-reformer; and
removing sulfur from the reformed gas by using the desulfurizer.

3. The fuel processing method as set forth in claim 2, wherein the post-reformer includes a catalyst formed of a transition metal, a noble metal or a mixture thereof, and the low carbon hydrocarbon compound of C₂˜C₅ is converted into hydrogen and methane by the catalyst.

4. The fuel processing method as set forth in claim 3, wherein the transition metal includes Ni, Mg and a mixture thereof, and the noble metal includes Pt, Rh, Pd, Ru and a mixture thereof.

5. The fuel processing method as set forth in claim 3, wherein the selectively decomposing of the low carbon hydrocarbon compound of C₂˜C₅ contained in desulfurized reformed gas and the converting of it into hydrogen and methane using the post-reformer is performed at 400˜600° C.

6. The fuel processing method as set forth in claim 2, wherein an autothermal reforming reaction among fuel, air and water is performed in the primary-reformer of the obtaining of the hydrogen-rich reformed gas from the hydrocarbon-based fuel using the primary-reformer, and an adsorption reaction of a sulfur compound with respect to the catalyst is performed in the desulfurizer of the removing of sulfur from the reformed gas using the desulfurizer, and heat generated from the adsorption reaction and the autothermal reaction is used as a heat source for the selectively decomposing of the low carbon hydrocarbon compound of C₂˜C₅ contained in desulfurized reformed gas and the converting of it into hydrogen and methane using the post-reformer.

7. The fuel processing method as set forth in claim 1, wherein the post-reformer includes a catalyst formed of a transition metal, a noble metal or a mixture thereof, and the low carbon hydrocarbon compound of C₂˜C₅ is converted into hydrogen and methane by the catalyst.
